(19) United States
(12) Patent Application Publication
(10) Pub. No.: US 2012/0172539 A1
(43) Pub. Date: Jul. 5, 2012

(54) Heat-Resistant Polyamide Resin Composition and Method of Preparing the Same

(75) Inventors: So Young Kwon, Uiwang-si (KR); Young Sub Jin, Uiwang-si (KR); Sang Kyun Lim, Uiwang-si (KR); Bok Nam Jang, Uiwang-si (KR); Seung Hyun Jang, Uiwang-si (KR); Ki Yon Lee, Uiwang-si (KR); Suk Min Jun, Uiwang-si (KR)

(73) Assignee: CHEIL INDUSTRIES INC., Gumi-si (KR)

(21) Appl. No.: 13/339,808

(22) Filed: Dec. 29, 2011

(30) Foreign Application Priority Data
Dec. 31, 2010 (KR) 2010-0140182
Apr. 6, 2011 (KR) 2011-0031525

(51) Int. Cl. C08G 69/48; C08G 69/26

(52) U.S. Cl. 525/420

(57) ABSTRACT

A polyamide resin produced by polymerization of an aliphatic diamine monomer mixture (A) and polyester resin (B) is disclosed. The aliphatic diamine monomer mixture (A) includes an aliphatic diamine monomer (a1) having 2 to 6 carbon atoms, and an aliphatic diamine monomer (a2) having 6 to 12 carbon atoms, with the proviso that (a1) and (a2) are different and have a different number of carbon atoms. A method to produce the polyamide resin is also disclosed. The polyamide resin can have excellent heat resistance, low hygroscopic property and good color.

### CROSS-REFERENCE TO RELATED APPLICATIONS

This application claims priority under 35 USC Section 119 to and the benefit of Korea Patent Application No. 10-2010-0140182 filed on Dec. 31, 2010 and Korea Patent Application No. 10-2011-0031525 filed on Apr. 6, 2011 in the Korean Intellectual Property Office, the disclosure of each of which is incorporated herein by reference in its entirety.

### FIELD OF THE INVENTION

The present invention relates to polyamide resin and a method for preparing the same.

### BACKGROUND OF THE INVENTION

Well-known polyester resins include polyethylene terephthalate (PET) and polybutylene terephthalate (PBT). These polyester resins can be used in various applications such as films, fibers, bottles, packaging materials, and the like. After use, the polyester resin product can be disposed or can be recycled. It can be difficult, however, to recycle polyester resin. Accordingly, there is a need for improved methods of recycling polyester products.

One method for recycling polyester resin includes converting low value recycled polyester resin into high value heat resistance polyamide resin. The heat resistant polyamide resin may be widely used in various applications requiring heat resistance, for example auto parts, electric and electronic products, mechanical parts, and the like.

Examples of methods for converting polyester resin into polyamide resin are disclosed in U.S. Pat. No. 5,837,803, JP 4,317,615, and JP 3,664,577. For example, linear polyester resin having an intrinsic viscosity of 0.2 dl/g or above can be reacted with a diamine compound to produce a polyamide resin or polyester amide resin partially replaced with amide group. These methods use carboxylic acid activator or inorganic salt enzymes; solvents such as methylpyrrolidone (NMP), normal dodecylbenzene, orthodichlorobenzene, sulfolane, and the like; and hexamethylene diamine or paraphenylene diamine as the diamine. Because these methods use a solvent in the amidation reactions, the solvent used along with the reactants must be collected after the reactions are completed.

KR 2002-70589 includes a batch process that reacts the polyester resin with diamine compound in the presence of an organic solvent and an esterification catalyst, and a semibatch process that polycondenses the batch product by removing glycol components. Glycol components are removed by incorporating nitrogen gas into a reactor instead of using a high vacuum in order to promote the removal of glycol components by evaporation. Preferably, this method produces polyparaphenylene terephthalamide (a wholly aromatic polyamide), which can have high heat resistance but poor processability, using an esterification catalyst and normal dodecylbenzene as a solvent. Therefore, this method is limited to auto parts, electric and electronic products, and mechanical parts.

### SUMMARY OF THE INVENTION

The present invention provides polyamide resin that can have excellent heat resistance. The polyamide resin can be produced by polymerization of an aliphatic diamine monomer mixture (A) and polyester resin (B), wherein the aliphatic diamine monomer mixture (A) comprises aliphatic diamine monomer (a1) having 2 to 6 carbon atoms and aliphatic diamine monomer (a2) having 6 to 12 carbon atoms, with the proviso that (a1) and (a2) are different and have a different number of carbon atoms.

In exemplary embodiments, the polyamide resin can have a number of amine ends of about 30 μeq/g to about 1,000 μeq/g by reacting an ester group of the polyester resin (B) with the aliphatic diamine monomer (a1) or (a2) or a combination thereof.

In exemplary embodiments, the polyamide resin can include a ratio (A/B) of total mole of the aliphatic diamine monomer compound (A) and total mole of polyester resin (B) of about 0.90 to about 1.50.

In exemplary embodiments, the polyamide resin further comprises an endcapping agent. Examples of the endcapping agent include without limitation aliphatic carboxylic acids such as acetic acid, propionic acid, butyric acid, valeric acid, caproic acid, caprilic acid, lauric acid, tridecane acid, myristic acid, palmitic acid, stearic acid, pivalic acid, and isobutylic acid; aromatic carboxylic acids such as benzoic acid, toluic acid, α-naphtalene carboxylic acid, β-naphtalene carboxylic acid, and methyl naphthalene carboxylic acid, aliphatic carboxylic acid esters such as methyl acetate, ethylacetate, propylacetate, butylacetate, amylacetate, and 2-etoxyethyl acetate; aromatic carboxylic acid esters such as methyl benzoate, ethyl benzoate, propyl benzoate, butyl benzoate, and pentyl benzoate; and the like, and combinations thereof.

The present invention further provides a method for producing polyamide resin. In exemplary embodiments the method includes:

(1) reacting an aliphatic diamine monomer mixture (A) comprising an aliphatic diamine monomer (a1) having 2 to 6 carbon atoms and an aliphatic diamine monomer (a2) having 6 to 12 carbon atoms, with the proviso that (a1) and (a2) are different and have a different number of carbon atoms; polyester resin (B); and an endcapping agent (C) in the presence of a catalyst, such as a phosphorous catalyst, for a period of about 2 hours at a temperature of about 120 to about 140° C.;

(2) increasing the temperature, for example to about 140 to about 180° C., and maintaining the temperature, for example for about 2 to about 4 hours; and

(3) removing byproducts such as ethylene glycol, for example by reducing the pressure to about 2 to about 10 mbar at a temperature of about 180 to about 200° C. for about 3 to about 22 hours to evaporate the byproducts.

### DETAILED DESCRIPTION OF THE INVENTION

The present invention now will be described more fully hereinafter in the following detailed description of the invention in which some but not all embodiments of the invention are described. Indeed, this invention may be embodied in many different forms and should not be construed as limited to the embodiments set forth herein; rather, these embodiments are provided so that this disclosure will satisfy applicable legal requirements.

A method of manufacturing a heat resistant polyamide resin according to the present invention provides polyamide resin in which an ester group of polyester is wholly or partially amidated. The method of the invention includes reacting polyester resin with a mixture of aliphatic diamines without using organic solvent. In exemplary embodiments, the polyamide resin can be prepared by reacting a mixture of aliphatic diamine monomer (a1) having 2 to 6 carbon atoms with good reactivity and aliphatic diamine monomer (a2) having 6 to 12 carbon atoms, with the proviso that (a1) and (a2) are different and have a different number of carbon atoms with polyester resin (B) so that an ester group of the polyester resin (B) reacted with diamine is wholly or partially amidated. The resultant polyamide resin can have excellent heat resistance and low hygroscopic property.

In exemplary embodiments, the polyester resin (B) is polyethylene terephthalate, and the aliphatic diamine monomer mixture (A) comprises aliphatic diamine monomer (a1) and aliphatic diamine monomer (a2). The aliphatic diamine monomer (a1) has 2 to 6 carbon atoms, and the aliphatic diamine monomer (a2) has 6 to 12 carbon atoms. The number of carbon atoms of the aliphatic diamine monomer (a1) and (a2) are different from each other, although the number of carbon atoms of each falls within the range of carbon atoms described above.

The aliphatic diamine monomer mixture (A) can include about 10 to about 60 parts by weight of the aliphatic diamine monomer (a1) having 2 to 6 carbon atoms and about 10 to about 60 parts by weight of the aliphatic diamine monomer (a2) having 6 to 12 carbon atoms, each based on about 100 parts by weight of the polyester resin (B).

In some embodiments, the aliphatic diamine monomer mixture (A) can include the aliphatic diamine monomer (a1) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 parts by weight. Further, according to some embodiments of the present invention, the amount of the aliphatic diamine monomer (a1) can be in a range from about any of the foregoing amounts to about any other of the foregoing amounts.

In some embodiments, the aliphatic diamine monomer mixture (A) can include the aliphatic diamine monomer (a2) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 parts by weight. Further, according to some embodiments of the present invention, the amount of the aliphatic diamine monomer (a2) can be in a range from about any of the foregoing amounts to about any other of the foregoing amounts.

The polyamide resin may include about 30 to about 70 mol % of the aliphatic diamine monomer mixture (A). In some embodiments, the polyamide resin may include may include the aliphatic diamine monomer mixture (A) in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 mol %. Further, according to some embodiments of the present invention, the amount of the aliphatic diamine monomer mixture (A) can be in a range from about any of the foregoing amounts to about any other of the foregoing amounts.

The ratio of the total moles of the aliphatic diamine monomer mixture (A) and the total moles of the polyester resin (B) (calculated based on the repeated units) can be about 0.90 to about 1.50.

Each of the aliphatic diamine monomers (a1) and (a2) may have a linear or branched structure.

Examples of the aliphatic diamine monomer (a1) include without limitation 1,2-ethanediamine, 1,4-butanediamine, 1,5-pentanediamine, 1,6-hexanediamine, 2-methylpentanediamine, 3-methyl-1,5-pentanediamine, and the like, and combinations thereof.

Examples of the aliphatic diamine monomer (a2) include without limitation 1,6-hexanediamine, 1,7-heptanediamine, 1,8-octanediamine, 1,9-nonanediamine, 1,10-decanediamine, 1,11-undecanediamine, 1,12-dodecane diamine, 3-methyl-1,5-pentanediamine, 2,2,4-trimethyl-1,6-hexanediamine, 2,4,4-trimethyl-1,6-hexanediamine, 5-methyl-1,9-nonanediamine, 2,2-oxybis(ethylamine), bis(3-aminopropyl)ether, ethylene glycol bis(3-aminopropyl)ether (EGBA), 1,7-diamino-3,5-dioxoheptane, 1,10-diamino-4,7-dioxoundecane, 1,10-diamino-4,7-dioxo-5-methyldecane, 1,11-undecanediamine, 1,12-dodecanediamine, 2-butyl-2-ethyl-1,5-pentanediamine, and the like, and combinations thereof.

Any aromatic or aliphatic polyester resin can be used as the polyester resin (B) without limitation. In exemplary embodiments, the polyester resin (B) can be an aromatic polyester resin, for example, polyethylene terephthalate resin.

The present invention may further comprise an end capping agent (C). By controlling an amount and application time of the end capping agent, viscosity of the polyamide resin, the number of amide ends, and the degree of amidation (DA) after amidation reaction can be controlled.

The polyamide resin of the invention can have an intrinsic viscosity [η] of about 0.2 dL/g to about 4.0 dL/g, and a number of amine ends of about 30 μeq/g to about 1,000 μeq/g. Intrinsic viscosity of the polyamide resin can be measured using standard techniques and conditions well known to the skilled artisan, for example, by melting polyamide into concentrated sulfuric acid (98%) and measuring the intrinsic viscosity thereof using an Ubbelodhde viscometer at 25° C.

Examples of the end capping agent used in the present invention can include without limitation aliphatic carboxylic acids, aromatic carboxylic acids, aliphatic carboxylic acid esters, aromatic carboxylic acid esters, and the like, and combinations thereof. Examples of the aliphatic carboxylic acids can include without limitation acetic acid, propionic acid, butyric acid, valeric acid, caproic acid, caprilic acid, lauric acid, tridecane acid, myristic acid, palmitic acid, stearic acid, pivalic acid, isobutylic acid, and the like, and combinations thereof. Examples of aromatic carboxylic acids can include without limitation benzoic acid, toluic acid, α-naphtalene carboxylic acid, β-naphtalene carboxylic acid, methyl naphthalene carboxylic acid, and the like, and combinations thereof. Examples of the aliphatic carboxylic acid esters can include without limitation methyl acetate, ethyl acetate, propyl acetate, butyl acetate, amyl acetate, 2-etoxyethyl acetate, and the like, and combinations thereof. Examples of the aromatic carboxylic acid esters can include without limitation methyl benzoate, ethyl benzoate, propyl benzoate, butyl benzoate, pentyl benzoate, and the like, and combinations thereof. The end capping agents can be used alone or in combination with two more.

The endcapping agent used in the preparation of polyamide resin in the present invention may be included in an amount of about 0.01 to about 10.0 parts by weight, for example about 0.01 to about 5.0 parts by weight, based on about 100 parts by weight of the polyester resin (B). In some embodiments, the endcapping agent may be used in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of the endcapping agent can be in a range from about any of the foregoing amounts to about any other of the foregoing amounts.

Method of Producing the Polyamide Resin

In the manufacturing method of the invention, the aliphatic diamine monomer mixture (A) including aliphatic diamines (a1) and (a2) with a different number of carbon atoms as discussed herein and polyester resin (B) are added to a reactor with an endcapping agent and reacted under conditions sufficient to form a polyamide prepolymer. In exemplary embodiments, the aliphatic diamine monomer mixture (A), polyester (B), endcapping agent and catalyst can be added to a reactor and stirred for about 2 hours at a temperature of about 120 to about 140° C. Then the temperature can be increased to about 140 to about 180° C. and maintained for about 2 to about 4 hours. Then, the pressure can be reduced to remove byproducts such as ethylene glycol by evaporation. In exemplary embodiments, the pressure can be reduced to about 2 (or less) millibar (mbar) to about 10 mbar at a temperature of about 180 to about 200° C. for about 3 to about 22 hours.

The resultant polyamide may be solid state polymerized. In exemplary embodiments, the resultant polyamide may be solid state polymerized for a period of about 10 to about 30 hours under a vacuum at a temperature between the glass transition temperature and melting temperature of the polyamide to increase amidation response rate and the viscosity of the polymer. In exemplary embodiments, the polymerization temperature is about 180 to about 250° C., for example about 200 to about 230° C.

The catalyst used in the present invention may be a phosphorus catalyst. Examples of the phosphorus catalyst may include without limitation phosphoric acid, phosphorous acid, hypophosphorous acid, salts or derivatives thereof, and the like, and combinations thereof. In exemplary embodiments, phosphoric acid, phosphorus acid, hypophosphorous acid, sodium hypophosphate, sodium hypophosphinate and the like, and combinations thereof may be used.

The catalyst used in the preparation of polyamide resin in the present invention may be used in an amount of about 0.01 to about 3.0 parts by weight, for example about 0.01 to about 1.0 parts by weight, and as another example about 0.01 to about 0.5 parts by weight, based on about 100 parts by weight of the polyester resin (B).

The present invention may be better understood by examples below, which are for only illustrative purposes and are not intended to limit the scope of claims.

### EXAMPLE

### Example 1

100 parts by weight polyethylene terephthalate (PET), 13.1 parts by weight 1,2-ethanediamine, 38.1 parts by weight 1,6-hexanediamine, 6.36 parts by weight benzoic acid, and 0.16 parts by weight sodium hypophosphinate are placed into a 1 liter autoclave, which is charged with nitrogen and purged several times to remove oxygen. The reactor is sealed and the reactants stirred for 2 hours at 120° C. Then the temperature is increased to 140° C. for 30 min and the reactants are reacted for 2 hours at the same temperature. The temperature is increased for 60 min to 180° C., and the reactants are maintained for 4 hours at this temperature. Then the pressure is reduced to less than 2 mbar to remove ethylene glycol. 30 parts by weight of ethylene glycol is collected. After completion of the reaction, a polyamide prepolymer with an intrinsic viscosity of 0.20 dL/g level is collected.

A polyamide prepolymer obtained through the above method is subjected to solid state polymerization for 24 hours at 230° C. to provide a polyamide resin with an intrinsic viscosity of 1.0 dL/g.

### Example 2

A prepolymer is produced using the same method of Example 1, except for using 100 parts by weight PET, 19.1 parts by weight 1,4-butanediamine, 37.7 parts by weight 1,6-hexanediamine, 5.1 parts by weight benzoic acid, and 0.16 parts by weight sodium hypophosphinate. After completion of the reaction, a polyamide prepolymer with an intrinsic viscosity of 0.23 dL/g level is collected.

The polyamide prepolymer obtained by the method above is subject to further solid state polymerization for 24 hours at 230° C. to provide a polyamide resin with an intrinsic viscosity of 1.05 dL/g.

### Example 3

A polyamide prepolymer is produced using the same method of Example 1, except for using 100 parts by weight PET, 37.3 parts by weight 1,6-hexanediamine, 31.0 parts by weight 1,8-octanediamine, 3.8 parts by weight benzoic acid, and 0.17 parts by weight sodium hypophosphinate. After completion of the reaction, a polyamide prepolymer with an intrinsic viscosity of 0.22 dL/g level is collected.

The polyamide prepolymer obtained by the method above is subject to further solid state polymerization for 24 hours at 230° C. to provide a polyamide resin with an intrinsic viscosity of 0.98 dL/g.

### Example 4

A polyamide prepolymer is produced using the same method of Example 1, except for using 100 parts by weight PET, 43.1 parts by weight 1,6-hexanediamine, 27.5 parts by weight 1,10-decanediamine, 2.5 parts by weight benzoic acid, and 0.17 parts by weight sodium hypophosphinate. After completion of the reaction, a polyamide prepolymer with an intrinsic viscosity of 0.20 dL/g level is collected.

The polyamide prepolymer obtained by the method above is subject to further solid state polymerization for 24 hours at 230° C. to provide a polyamide resin with an intrinsic viscosity of 1.02 dL/g.

### Example 5

A polyamide prepolymer is produced using the same method of Example 1, except for using 100 parts by weight PET, 42.7 parts by weight 1,6-hexanediamine, 31.6 parts by weight 1,12-dodecanediamine, 1.27 parts by weight benzoic acid, and 0.18 parts by weight sodium hypophosphinate. After completion of the reaction, a polyamide prepolymer with an intrinsic viscosity of 0.23 dL/g level is collected.

The polyamide prepolymer obtained by the method above is subject to further solid state polymerization for 24 hours at 230° C. to provide a polyamide resin with an intrinsic viscosity of 1.01 dL/g.

### Example 6

A polyamide prepolymer is produced using the same method of Example 1, except for using 100 parts by weight PET, 13.1 parts by weight 1,2-ethanediamine, 38.1 parts by weight 1,6-hexanediamine, 7.1 parts by weight methyl benzoate, and 0.16 parts by weight sodium hypophosphinate. After completion of the reaction, a polyamide prepolymer with an intrinsic viscosity of 0.22 dL/g level is collected.

The polyamide prepolymer obtained by the method above is subject to further solid state polymerization for 24 hours at 230° C. to provide a polyamide resin with an intrinsic viscosity of 1.04 dL/g.

### Example 7

100 parts by weight PET, 13.1 parts by weight 1,2-ethanediamine, 38.1 parts by weight 1,6-hexanediamine, 6.36 parts by weight benzoic acid, and 0.16 parts by weight sodium hypophosphinate are placed into a 1 liter of autoclave, which is charged with nitrogen and purged several times to remove oxygen. The reactor is sealed and the reactants are stirred for 2 hours at 140° C. Then the temperature is raised to 160° C. for 30 minutes, and the reactants are reacted for 2 hours at the same temperature. The temperature is raised for 60 min to 180° C., and the reactants are maintained for 4 hours at this temperature. Then the pressure is reduced to less than 2 mbar to remove ethylene glycol. After completion of the reaction, a polyamide prepolymer with an intrinsic viscosity of 0.28 dL/g is collected.

The polyamide prepolymer obtained by the method above is subject to further solid state polymerization for 24 hours at 230° C. to provide a polyamide resin with an intrinsic viscosity of 1.08 dL/g.

### Example 8

A polyamide prepolymer is produced using the same method of Example 1, except for using 100 parts by weight PET, 43.1 parts by weight 1,6-hexanediamine, 27.5 parts by weight 1,10-decanediamine, and 0.17 parts by weight sodium hypophosphinate. After completion of the reaction, a polyamide prepolymer with an intrinsic viscosity of 0.25 dL/g is collected.

The polyamide prepolymer obtained by the method above is subject to further solid state polymerization for 24 hours at 230° C. to provide a polyamide resin with an intrinsic viscosity of 1.24 dL/g.

### Comparative Example 1

A polyamide prepolymer is produced using the same method of Example 1, except for using 100 parts by weight PET, 62.2 parts by weight 1,6-hexanediamine, 3.8 parts by weight benzoic acid, and 0.17 parts by weight sodium hypophosphinate. After completion of the reaction, a polyamide prepolymer with an intrinsic viscosity of 0.15 dL/g is collected.

The polyamide prepolymer obtained by the method above is subject to further solid state polymerization for 24 hours at 230° C. to provide a polyamide resin with an intrinsic viscosity of 0.35 dL/g.

### Comparative Example 2

A polyamide prepolymer is produced using the same method of Example 1, except for using 100 parts by weight PET, 13.1 parts by weight 1,2-ethanediamine, 28.9 parts by weight 1,4-butanediamine, 6.4 parts by weight benzoic acid, and 0.15 parts by weight sodium hypophosphinate. After completion of the reaction, a polyamide prepolymer with an intrinsic viscosity of 0.10 dL/g is collected.

The polyamide prepolymer obtained by the method above is subject to further solid state polymerization for 24 hours at 230° C. to provide a polyamide resin with an intrinsic viscosity of 0.21 dL/g.

### Comparative Example 3

A polyamide prepolymer is produced using the same method of Example 7, except for sealing the reactor, stirring it for 2 hours at 80° C., raising the temperature to 100° C. for 30 min and reacting it at this temperature for 2 hours. After completion of the reaction, a polyamide prepolymer with an intrinsic viscosity of 0.10 dL/g level is collected.

The polyamide prepolymer obtained by the method above is subject to further solid state polymerization for 24 hours at 230° C. to provide a polyamide resin with an intrinsic viscosity of 0.15 dL/g.

### Physical Properties Evaluation

Samples of the polyamide resins produced from the examples and comparative examples before and after solid phase polymerization are measured for heat properties, intrinsic viscosity and end groups. Heat properties are measured using a Differential Scanning calorimeter (DSC) and Thermogravimetric analyzer (TGA). After melting polyamide into concentrated sulfuric acid (98%), the intrinsic viscosity is measured using an Ubbelodhde viscometer at 25° C. The measurement of acid end groups is achieved by completely melting polyamide into o-cresol and using 0.1N KOH solution on a potential difference measurement. The measurement of amine end groups is achieved by completely melting polyamide into hexafluoroisopropanol and using 0.1N HCl solution on the potential difference measurement.

To measure water hygroscopic property, a sample having 100 mm length, 100 mm width and 3 mm thickness is produced and dried. The dried weight (W₀) of the sample is measured, and then the weight (W₁) of the sample is measured after maintaining the sample at a temperature of 80° C. and a relative humidity (RH) of 90% for 48 hours in a thermo-hygrostat.

Water hygroscopic property(%)=[(W₁−W₀)/W₀]*100

The brightness L* value is measured by using a colorimeter in accordance with ASTM D 1209.

TABLE 1
(component units: parts by weight)

| | example | | | | | | | | Comparative example | | |
|---|---|---|---|---|---|---|---|---|---|---|---|
| | 1 | 2 | 3 | 4 | 5 | 6 | 7 | 8 | 1 | 2 | 3 |
| PET | 100 | 100 | 100 | 100 | 100 | 100 | 100 | 100 | 100 | 100 | 100 |
| 1,2-ethanediamine | 13.1 | — | — | — | — | 13.1 | 13.1 | — | — | 13.1 | 13.1 |
| 1,4-butanediamine | — | 19.1 | — | — | — | — | — | — | — | 28.9 | — |
| 1,6-hexanediamine | 38.1 | 37.7 | 37.3 | 43.1 | 42.7 | 38.1 | 38.1 | 43.1 | 62.2 | — | 38.1 |
| 1,8-octanediamine | — | — | 31.0 | — | — | — | — | — | — | — | — |
| 1,10- | — | — | — | 27.5 | — | — | — | 27.5 | — | — | — |
| decanediamine | | | | | | | | | | | |
| 1,12- | — | — | — | — | 31.6 | — | — | — | — | — | — |
| dodecanediamine | | | | | | | | | | | |
| Benzoic acid | 6.36 | 5.1 | 3.8 | 2.5 | 1.27 | — | 6.36 | — | 3.8 | 6.4 | 6.36 |
| Methylbenzoate | — | — | — | — | — | 7.1 | — | — | — | — | — |
| Sodium | 0.16 | 0.16 | 0.17 | 0.17 | 0.18 | 0.16 | 0.16 | 0.17 | 0.17 | 0.15 | 0.16 |
| hypophosphinate | | | | | | | | | | | |
| Melting temp. (° C.) | 300 | 295 | 290 | 320 | 318 | 303 | 305 | 310 | Fail | Fail | Fail |
| Crystallization | 260 | 263 | 265 | 298 | 297 | 261 | 265 | 280 | Fail | Fail | Fail |
| temp. (° C.) | | | | | | | | | | | |
| Pyrolysis temp | 430 | 435 | 440 | 444 | 445 | 435 | 435 | 440 | 418 | 420 | 417 |
| (° C.) | | | | | | | | | | | |
| Intrinsic viscosity | 1.00 | 1.05 | 0.98 | 1.02 | 1.01 | 1.04 | 1.08 | 1.24 | 0.35 | 0.21 | 0.15 |
| (dL/g) | | | | | | | | | | | |
| Acid end group | 80 | 85 | 75 | 60 | 50 | 83 | 75 | 65 | 100 | 105 | Fail |
| (μeq/g) | | | | | | | | | | | |
| Amine end group | 150 | 130 | 100 | 65 | 40 | 130 | 121 | 150 | 500 | 1000 | Fail |
| (μeq/g) | | | | | | | | | | | |
| hygroscopic | 4.5 | 4.2 | 2.8 | 2.0 | 1.5 | 4.4 | 4.2 | 2.4 | 4.0 | 5.9 | 6.5 |
| property (%) | | | | | | | | | | | |
| Brightness (L*) | 80 | 85 | 88 | 92 | 95 | 82 | 84 | 90 | 65 | 67 | 63 |

Referring to Table 1, the polyamide resins in examples 1 to 8 have an excellent melting temperature, crystallization temperature and pyrolysis temperature, indicating that these resins have excellent heat resistance. In addition, the resins of examples 1 to 8 have excellent brightness and low hygroscopic property, which means that an excellent color expression is possible. In addition, the number of acid end groups and the number of amine end groups are lower than the comparative examples.

The polyamide resin of comparative example 1 did not have heat resistance, because comparative example 1 uses one kind of aliphatic diamine monomer (1,6 hexane diamine), and the melting temperature and crystallization temperature could not be measured due to low reactivity. Similar to comparative example 1, the polyamide resin of comparative example 2 did not have heat resistance, since comparative example 2 used two kinds of aliphatic diamine monomers with 6 or fewer carbon atoms.

In comparative example 3 solid phase polymerization is conducted using conditions of time and temperature outside of the range of the present invention. Therefore, it is impossible to measure melting temperature, crystallization temperature, and acid and amine end group due to low reactivity in comparative example 3.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polyamide resin produced by polymerization of an aliphatic diamine monomer mixture (A) and polyester resin (B), wherein the aliphatic diamine monomer mixture (A) comprises an aliphatic diamine monomer (a1) having 2 to 6 carbon atoms, and an aliphatic diamine monomer (a2) having 6 to 12 carbon atoms, with the proviso that (a1) and (a2) are different and have a different number of carbon atoms.

2. The polyamide resin of claim 1, wherein the aliphatic diamine monomer mixture (A) comprises about 10 to about 60 parts by weight of the aliphatic diamine monomer (a1) having 2 to 6 carbon atoms and about 10 to about 60 parts by weight of the aliphatic diamine monomer (a2) having 6 to 12 carbon atoms, based on about 100 parts by weight of the polyester resin (B).

3. The polyamide resin of claim 1, wherein the ester group of the polyester resin (B) reacts with the aliphatic diamine monomer (a1), (a2), or both such that the number of amine ends of the polyamide resin is about 30 μeq/g to about 1,000 μeq/g.

4. The polyamide resin of claim 1, wherein the ratio (A/B) of the total moles of the aliphatic diamine monomer mixture (A) and the total moles of polyester resin (B) (based on the repeated unit) is about 0.90 to about 1.50.

5. The polyamide resin of claim 1, wherein the aliphatic diamine monomer (a1) having 2 to 6 carbon atoms comprises 1,2-ethanediamine, 1,4-butanediamine, 1,5-pentanediamine, 1,6-hexanediamine, 2-methylpentanediamine, 3-methyl-1,5-pentanediamine or a combination thereof.

6. The polyamide resin of claim 1, wherein the aliphatic diamine monomer (a2) having 6 to 12 carbon atoms comprises 1,6-hexanediamine, 1,7-heptanediamine, 1,8-octanediamine, 1,10-decanediamine, 1,11-undecanediamine, 1,2-dodecanediamine, 3-methyl-1,5-pentanediamine, 2,2,4-trimethyl-1,6-hexanediamine, 2,4,4-trymethyl-1,6-hexanediamine, 5-methyl-1,9-nonanediamine, 2,2-oxybis(ethylamine), bis(3-aminopropyl)ether, ethylene glycol bis(3-aminopropyl)ether (EGBA), 1,7-diamino-3,5-dioxoheptane, 1,10-diamino-4,7-dioxoundecane, 1,10-diamino-4,7-dioxo-5-methyledecane, 1,-11-undecanediamine, 1,12-dodecanediamine, 2-butyl-2-ethyl-1,5-pentanediamine or a combination thereof.

7. The polyamide resin of claim 1, wherein the polyester resin (B) is aliphatic polyester resin or aromatic polyester resin.

8. The polyamide resin of claim 7, wherein the polyester resin (B) is polyethylene terephtalate (PET) resin.

9. The polyamide resin of claim 1, further comprising an endcapping agent (C) wherein the endcapping agent comprises an aliphatic carboxylic acid, an aromatic carboxylic acid, an aliphatic carboxylic acid ester, an aromatic carboxylic acid ester, or a combination thereof.

10. The polyamide resin of claim 9, wherein the endcapping agent (C) comprises an aliphatic carboxylic acid comprising acetic acid, propionic acid, butyric acid, valeric acid, caproic acid, caprilic acid, lauric acid, tridecane acid, myristic acid, palmitic acid, stearic acid, pivalic acid, isobutylic acid, or a combination thereof.

11. The polyamide resin of claim 9, wherein the endcapping agent (C) comprises an aromatic carboxylic acid comprising benzoic acid, toluic acid, α-naphtalenecarboxylic acid, β-naphtalenecarboxylic acid, methylnaphtalenecarboxylic acid, or a combination thereof.

12. The polyamide resin of claim 9, wherein the endcapping agent (C) comprises an aliphatic carboxylic acid ester comprising methylacetate, ethylacetate, propylacetate, butylacetate, amylacetate, 2-ethoxyethyl acetate, or a combination thereof.

13. The polyamide resin of claim 9, wherein the endcapping agent (C) comprises an aromatic carboxylic acid ester comprising methyl benzoate, ethyl benzoate, propyl benzoate, butyl benzoate, pentyl benzoate, or a combination thereof.

14. The polyamide resin of claim 9, wherein the number of amine ends of the polyamide resin is about 30 μeq/g to about 200 μeq/g.

15. The polyamide resin of claim 9, comprising the endcapping agent in an amount of about 0.01 to about 10.0 parts by weight, based on about 100 parts by weight of polyester resin (B).

16. The polyamide resin of claim 1, wherein the polyamide resin has an intrinsic viscosity of about 0.2 dL/g to about 4.0 dL/g.

17. A method for producing polyamide resin comprising:
reacting an aliphatic diamine monomer mixture (A) comprising an aliphatic diamine monomer (a1) having 2 to 6 carbon atoms and an aliphatic diamine monomer (a2) having 6 to 12 carbon atoms, with the proviso that (a1) and (a2) are different and have a different number of carbon atoms, polyester resin (B), and an endcapping agent (C) under condition sufficient to provide a polyamide prepolymer.

18. The method of claim 17, wherein the reacting step comprises:
reacting the aliphatic diamine monomer mixture (A) and the polyester resin (B) in the presence of a phosphorous catalyst for about 2 hours at a temperature of about 120 to about 140° C.; and
increasing the temperature to about 140 to about 180° C., maintaining the temperature for about 2 to about 4 hours to provide a polyamide prepolymer.

19. The method of claim 17, further comprising after the reacting step the step of reducing the pressure under conditions sufficient to remove byproducts from the polyamide prepolymer.

20. The method of claim 19, wherein the pressure reducing step comprises reducing the pressure to about 2 to about 10 mbar at a temperature of about 180 to about 200° C. for about 3 to about 22 hours to remove ethylene glycol byproduct.

21. The method of claim 17, further comprising subjecting the polyamide prepolymer to solid phase condensation.

22. The method of claim 21, wherein the solid phase condensation step is conducted in a vacuum for about 10 to about 30 hrs at a temperature of about 180 to about 250° C.

23. The method of claim 18, wherein the catalyst comprises phosphoric acid, phosphorous acid, hypophosphorous acid, sodium hypophosphate, sodium hypophosphinate or a combination thereof.

24. The method of claim 17, wherein the aliphatic diamine monomer mixture (A) comprises about 10 to about 60 parts by weight of the aliphatic diamine monomer (a1) and about 10 to about 60 parts by weight of the aliphatic diamine monomer (a2), based on about 100 parts by weight of the polyester resin (B); and wherein the endcapping agent is included in an amount of about 0.01 to about 10.0 parts by weight, based on about 100 parts by weight of the polyester resin (B).

25. The method of claim 18, wherein the phosphorous catalyst is included in an amount of about at 0.01 to about 3.0 parts by weight, based on about 100 parts by weight of the polyester resin (B).
